(19) United States
(12) Patent Application Publication
(10) Pub. No.: US 2016/0042304 A1
(43) Pub. Date: Feb. 11, 2016

(54) RISK-BASED EXECUTION FOR PROJECTS

(71) Applicant: Bank of America Corporation, Charlotte, NC (US)

(72) Inventors: Robert J. Maloney, Iron Station, NC (US); Larry Cravens, Matthews, NC (US); Emily LaForce, Charlotte, NC (US)

(21) Appl. No.: 14/456,781

(22) Filed: Aug. 11, 2014

(51) Int. Cl. G06Q 10/06

(52) U.S. Cl. CPC G06Q 10/0635

(57) ABSTRACT

Disclosed is a risk-based project management system. The risk-based project management system typically includes a processor, a memory, and a program module stored in the memory. During the planning phase of a project, the program and project management system is typically configured for: prompting a first user to provide inherent risk information regarding the project, receiving inherent risk information regarding the project; and based on the received inherent project risk information, calculating an inherent project risk score. During the execution phase of a project, the program and project management system is typically configured for receiving residual risk information regarding the project and, based on the received residual project risk information, calculating a residual project risk score.

### FIELD OF THE INVENTION

The present invention embraces a system for risk-based project management. The system typically includes a processor and a memory. The system typically includes a project module that is configured for calculating an inherent project risk score during the planning phase of a project and calculating a residual project risk score during the execution phase of a project.

### BACKGROUND

Project management is the discipline of planning, organizing, and controlling resources to achieve specific goals. Various software programs exist to help businesses engage in project management. That said, a need exists for an improved system for project management.

### SUMMARY

In one aspect, the present invention embraces a risk-based project management system and an associated method. The risk-based project management system typically includes a processor and a memory. The risk-based project management system also typically includes a project module stored in the memory and executable by the processor.

In one embodiment, the project module is configured for: receiving a first indication from a first user to initiate a project; based on the first indication to initiate the project, prompting the first user to complete predefined project plan phase tasks, wherein prompting the first user to complete the predefined project plan phase tasks includes prompting the first user to provide inherent risk information regarding the project, and define one or more business outcomes and associated metrics for the project; receiving inherent risk information regarding the project and one or more defined business outcomes for the project from the first user, wherein each defined project business outcome includes one or more associated metrics, based on the received inherent project risk information, calculating an inherent project risk score; receiving a second indication from the first user that the predefined project plan phase tasks have been completed; prompting the first user to complete predefined project execution phase tasks; receiving residual risk information regarding the project; and based on the received residual project risk information, calculating a residual project risk score.

In one particular embodiment, the project module is configured for : determining whether each defined project business outcome includes one or more associated metrics; comparing the inherent project risk score to a predefined project risk score threshold; based on (i) the inherent project risk score not exceeding the predefined project risk score threshold, (ii) each defined project business outcome including one or more associated metrics, and (iii) the second indication that the predefined project plan phase tasks have been completed, initiating a project plan tollgate, wherein initiating the project plan tollgate includes sending one or more project plan approval requests to one or more predefined project plan tollgate approvers; and receiving a project plan approval from each predefined project plan tollgate approver; wherein prompting the first user to complete predefined project execution phase tasks is based on receiving a project plan approval from each predefined project plan tollgate approver.

In another particular embodiment, the project module is configured for: before prompting the first user to complete the predefined project execution phase tasks, receiving initial residual risk information regarding the project, and, based on the received initial residual project risk information, calculating an initial residual project risk score; after prompting the first user to complete predefined project execution phase tasks, receiving updated residual risk information regarding the project, and, based on the received updated residual project risk information, calculating an updated residual project risk score; and calculating a project residual risk mitigation score, the residual risk mitigation score being the difference between the initial residual project risk score and the updated residual project risk score.

In yet another particular embodiment, the project module is configured for calculating a cumulative project risk score, the cumulative project risk score being the sum of the inherent project risk score and the residual project risk score.

In yet another particular embodiment, the project module is configured for, after prompting the first user to complete predefined project execution phase tasks, prompting the first user to provide residual risk information regarding the project.

In yet another particular embodiment, prompting the first user to provide residual risk information regarding the project includes periodically prompting the first user to provide residual risk information regarding the project; and calculating a residual project risk score includes periodically calculating a residual project risk score based on periodically received residual project risk information.

In yet another particular embodiment, prompting the first user to provide inherent risk information regarding the project includes prompting the first user to answer one or more questions regarding inherent risk; receiving inherent risk information regarding the project includes receiving answers to the one or more questions regarding inherent risk from the first user; prompting the first user to provide residual risk information regarding the project includes prompting the first user to answer one or more questions regarding residual risk; and receiving residual risk information regarding the project includes receiving answers to the one or more questions regarding residual risk from the first user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a program and project management system and operating environment in accordance with an exemplary embodiment of the present invention;

FIG. 2 schematically depicts a program and project management system in accordance with an exemplary embodiment of the present invention; and

FIGS. 3A-3B depicts a method of program and project management in accordance with an exemplary embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, assess management firms, insurance companies and the like. In specific embodiments of the invention, use of the term “bank” is limited to a financial entity in which account-bearing customers conduct financial transactions, such as account deposits, withdrawals, transfers and the like.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that engage in program and project management.

A “user” may be any person or entity using a program and project management system described herein. Often, a user is an employee of an entity (e.g., a financial institution) using a program and project management system. In some instances a user has a management position within an entity using a program and project management system.

As used herein, the term “program” relates to a large body of work that has the goal of achieving one or more business outcomes. A program may have a defined beginning and end or may be ongoing. In contrast, the term “project” relates to an endeavor within a program undertaken to provide one or more outputs. These outputs typically help to achieve one or more business goal of an overarching program. While a program is often ongoing, projects typically have a defined beginning and end.

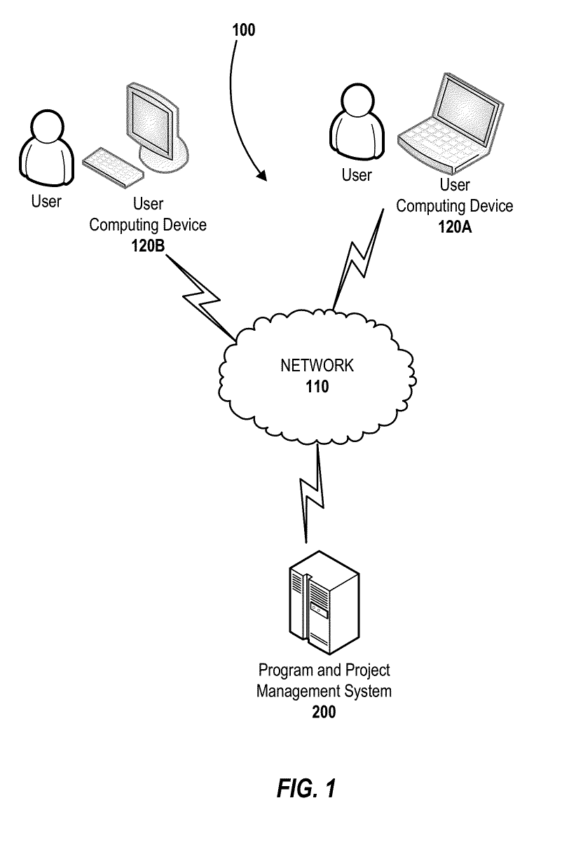

In one aspect, the present invention embraces a program and project management system that may be used by an entity, such as a financial institution, to engage in program and project management. In this regard, FIG. 1 depicts an operating environment 100 according to one embodiment of the present invention that facilitates program and project management. The operating environment includes a program and project management system 200. In addition, one or more users, each having a user computing device 120, such as a PC, laptop, mobile phone, tablet, television, mobile device, or the like, may be in communication with the program and project management system 200 via a network 100, such as the Internet, wide area network, local area network, Bluetooth network, near field network, or any other form of contact or contactless network.

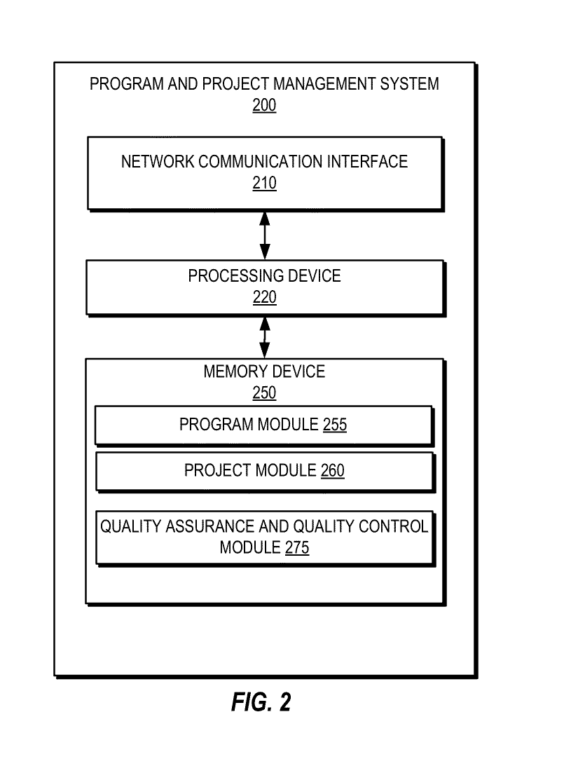

FIG. 2 depicts the program and project management system 200 in more detail. As depicted in FIG. 2 the program and project management system 200 typically includes various features such as a network communication interface 210, a processing device 220, and a memory device 250. The network communication interface 210 includes a device that allows the program and project management system 200 to communicate over the network 110 (shown in FIG. 1) with the user computing devices 120. In this regard, an interface (e.g., a graphical user interface) is typically presented on each user computing device to allow each user to interact with the program and project management system.

As used herein, a “processing device,” such as the processing device 220, generally refers to a device or combination of devices having circuitry used for implementing the communication and/or logic functions of a particular system. For example, a processing device 220 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 220 may further include functionality to operate one or more software programs based on computer-executable program code thereof, which may be stored in a memory. As the phrase is used herein, a processing device 220 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device,” such as the memory device 250, generally refers to a device or combination of devices that store one or more forms of computer-readable media for storing data and/or computer-executable program code/instructions. Computer-readable media is defined in greater detail below. For example, in one embodiment, the memory device 250 includes any computer memory that provides an actual or virtual space to temporarily or permanently store data and/or commands provided to the processing device 220 when it carries out its functions described herein.

As noted the program and project management system 200 is configured to perform program and project management. Accordingly, the program and project management system 200 typically includes one or more modules stored in the memory device 250, which facilitate program and project management. As depicted in FIG. 2, the program and project management system 200 typically includes a program module 255, a project module 260, and a quality assurance and control module 275.

The program module 255 is configured so that one or more users can interact (e.g., via user computing devices) with the program and project management system 200 in order to plan a program, view the status of the program, and execute the program.

In planning a program the program module 255 is typically configured prompt a user (e.g., via a graphical user interface (GUI) presented to the user) to complete one or more predefined tasks, each of which includes one or more predefined critical elements, before the program planning phase is completed. Typically, these predefined tasks and critical elements are defined by the entity (e.g., a financial institution). In some embodiments, the predefined tasks and critical elements may differ depending on the type of program (e.g., a type specified by the user creating the program). In an exemplary embodiment, the tasks of the program plan phase include (i) define program benefits and document business case, (ii) setup program and create program management plan (e.g., assign execution phase tasks and define dates for deliverables), (iii) document program business outcomes, (iv) summarize the target environment, and (v) evaluate program risk and determine program rigor. That said, other program plan phase tasks are within the scope of the present invention. In one embodiment, the program module 255 is configured so that the program plan phase cannot be completed until each predefined task and critical element has been completed. In this regard, the program module 255 may be configured to transmit a request for approval to a qualified user (e.g., a manager) once a predefined task or critical element has been completed. The qualified user can subsequently transmit an approval of the task or critical element to the program and project management system 200. Which users are qualified to approve certain tasks and critical elements may be defined in the program and project management system 200. In some embodiments, the program module 255 is configured to prevent the program from proceeding to the execution phase if any required task or critical element has not been approved. Each approval is typically documented by the program module 255.

With respect to the task of evaluating program risk and determining program rigor, the program module 255 may prompt the user(s) setting up the program to provide information regarding one or more risks associated with the program. In this regard, the user(s) may provide the program module 255 with information such as the type of each risk, a description of the risks, the severity of each risk, the probability of each risk, and the quality of control for each risk (e.g., the extent to which the risk can be controlled and managed). In some embodiments, the program module 255 is configured so that this information (i.e., the type of each risk, a description of the risks, the severity of each risk, the probability of each risk, and the quality of control for each risk) must be provided for each risk identified by the user(s) before the task of evaluating program risk and determining program rigor can be completed. In one embodiment, the user(s) may be prompted to provide information about certain predefined risks (e.g., depending on the rigor level and/or type of the program). In other words, the user(s) may be required to provide information about certain risks regardless of whether or not the user identifies that risk to the system. In some embodiments, a user may be designated to address one or more identified risks. In some embodiments, the program module 255 may be configured to allow the user(s) to choose from several predefined options for the type of each risk, the severity of each risk, the probability of each risk, and the quality of control for each risk. By way of example, the program module 255 may prompt the user to select a risk type from a drop down menu listing predefined risk types. By way of further example, the program module 255 may prompt the user to define whether a risk has a low, medium, or high probability of occurring. In one embodiment, the risk profile of a similar program or project may be cloned (e.g., copied) to aid in the entry of risk information associated with a new program. Once the risk information has been entered, an approval request may be transmitted to one or more qualified users (e.g., a risk approver), who can then approve or disapprove the risk information. Based on the entered risk information, the program module 255 may calculate a risk score of the program. If the risk score exceeds a predefined threshold, the program module 255 may then execute a predefined risk remediation plan and/or risk management plan. In a particular embodiment, if the risk score exceeds a predefined threshold, the program module 255 may be configured to not proceed past the program plan phase.

In addition to risk information, the program module 255 may prompt the user(s) setting up the program to provide information regarding the level of rigor that should be applied to the program. The level of rigor typically relates to the level of scrutiny that is applied to the program to ensure that the program achieves its defined business outcomes and does not negatively impact the entity as a whole. For example, a program may be determined to have a high rigor or a standard rigor. Programs having higher rigor may be required by the program module 255 to complete additional tasks during the execution phase and may be required to complete additional quality assurance and/or quality control steps. In order to determine the level of rigor, one or more users may be prompted by the program module 255 to provide their suggested level of rigor. In addition or alternatively, the program module 255 may prompt the user(s) setting up the program to provide certain information (e.g., by presenting one or more questions to be answered by the user(s)) that can then be used by the program module 255 to calculate a rigor score. The calculated rigor and/or suggested rigor may then be provided to a predefined user, who can then review the calculated rigor and/or suggested rigor and subsequently provide the program module 255 with a final rigor level.

With respect to the task of documenting business outcomes, the program module 255 may prompt the user(s) setting up the program to provide information regarding one or more business outcomes (e.g., goals) of the program. Typically, the program module 255 is configured so that at least one business outcome must be provided. The program module 255 is also typically configured to prompt the user(s) setting up the program to define one or more metrics for each outcome. These metrics may be used to later measure the degree of success of the program in meeting a particular business outcome. Typically, the program module 255 is configured so that metrics must be provided for each defined business outcome (e.g., by determining whether the user has done so). In one embodiment, users may provide forecast information regarding one or more metrics. This forecast information may relate to how the users expect the program to perform over time. Once the business outcomes and related metrics have been defined, an approval request may be transmitted to one or more qualified users, who can then approve or disapprove the defined business outcomes.

Once all of the program plan phase tasks have been completed the program module 255 may designate that the program plan phase has been completed and may allow the program execution phase to begin. That said, in one embodiment, after the program plan phase tasks have been completed, the program module 255 is configured to execute a program plan tollgate. During the program plan tollgate, program plan approval requests are sent to one or more predefined users (e.g., tollgate approvers). Each approver can then review the program plan and determine whether or not to approve the plan. Each approver can then transmit an approval or denial of the program plan to the program and project management system 200. Once every predefined approver approves the program plan, the program module 255 may designate that the program plan phase has been completed and may allow the program execution phase to begin. However, if any approver does not approve the program plan, the program module 255 will typically notify the user(s) setting up the program and provide an opportunity for the program plan to be satisfactorily revised.

Once the program plan phase has been completed, the program module 255 is typically configured to prevent any changes to the program's plan unless a predefined change control procedure is executed. Accordingly, the program module 255 typically prevents any changes to the program's risk information, rigor level, or defined outcomes and metrics once the program plan phase has been completed. That said, changes to the program's risk information, rigor level, or defined outcomes and metrics may be performed through the predefined change control procedure. The predefined change control procedure typically requires that a proposed change (e.g., requested by a user) to the program's plan be submitted to one or more predefined user(s). These predefined users may review the proposed change and then transmit a change approval or denial to the program and project management system 200. Based on receiving an approval or denial, requested changes to the program's risk information, rigor level, or defined outcomes and metrics may or may not be made.

Once the program plan phase has been designated as completed by the program module 255, the program module 255 will initiate the program execution phase of the program. In this regard, the program module 255 is typically configured prompt a user to complete one or more predefined execution tasks, each of which includes one or more predefined critical elements. Typically, these predefined tasks and critical elements are defined by the entity. In an exemplary embodiment, the tasks of the program execution phase may differ depending on the level of rigor determined for the program. For example, the tasks of standard rigor programs may include (i) setup repository and systems of record for projects and (ii) execute control routines (e.g., to ensure that identified risks are mitigated and that business outcomes are met as measured against the predefined metrics), whereas the tasks of high rigor programs may include (i) create multigenerational plan, (ii) setup repository and systems of record for projects, (iii) define relationship between program and project success measures, and (iv) execute control routines. In this regard, the program module 255 is typically provided data regarding the completion of one or more business outcomes. The program module 255 typically then compares this data regarding business outcomes against relevant defined metrics. The progress towards the completion of the business outcomes may then be provided by the program module 255 to users (e.g., predefined users such as program managers). For example, information regarding actual results regarding a business outcome may be displayed alongside forecasted results regarding that business outcome. The program module 255 is typically configured so that certain users (e.g., program managers) can manage resources (e.g., manage people and assign them various responsibilities), view the status of the program (e.g., progress towards one or more tasks and the project dates for deployments), view information regarding one or more related projects (e.g., how related projects have progressed towards their defined business outcomes and how that progress relates, directly or indirectly, to the program's defined business outcomes), view information regarding risks (e.g., whether or not identified risks are resolved, unresolved, or being mitigated), and initiate change controls. The program module 255 may be configured so that certain users (e.g., program managers) can view results from plan phase and execution phase quality assurance and quality control. The system may prompt users that have been assigned a task to complete that task.

The project module 260 is configured so that one or more users can interact with the program and project management system 200 in order to plan a project, view the status of the project, and execute the project.

In planning a project the project module 260 is typically configured prompt a user to complete one or more predefined tasks, each of which includes one or more predefined critical elements, before the project planning phase is completed. Typically, these predefined tasks and critical elements are defined by the entity. In some embodiments, the predefined tasks and critical elements may differ depending on the type of project (e.g., a type specified by the user creating the project). In an exemplary embodiment, the tasks of the project plan phase include (i) define project benefits and document business case, (ii) setup project and create project management plan (e.g., assign execution phase tasks and define dates for deliverables), (iii) document project business outcomes, (iv) summarize the target environment, and (v) evaluate project risk. That said, other project plan phase tasks are within the scope of the present invention. In one embodiment, the project module 260 is configured so that the project plan phase cannot be completed until each predefined task and critical element has been completed. In this regard, the project module 260 may be configured to transmit a request for approval to a qualified user (e.g., a manager) once a predefined task or critical element has been completed. The qualified user can subsequently transmit an approval of the task or critical element to the program and project management system 200. Which users are qualified to approve certain tasks and critical elements may be defined in the program and project management system 200. In some embodiments, the project module 260 is configured to prevent the project from proceeding to the execution phase if any required task or critical element has not been approved. Each approval is typically documented by the project module 260.

In setting up the project one or more dependencies may be defined. In this regard, each project typically relates to at least one program (e.g., the project helps to achieve one or more business outcomes of the program to which it depends). In addition, the project may depend on one or more other projects.

With respect to the task of evaluating project risk, the project module 260 may prompt the user(s) setting up the project to provide information regarding one or more risks associated with the project. In this regard, the user(s) may provide the project module 260 with information such as the type of each risk, a description of the risks, the severity of each risk, the probability of each risk, and the quality of control for each risk. In some embodiments, the project module 260 is configured so that this information (i.e., the type of each risk, a description of the risks, the severity of each risk, the probability of each risk, and the quality of control for each risk) must be provided for each risk identified by the user(s) before the task of evaluating project risk can be completed. In one embodiment, the user(s) may be prompted to provide information about certain predefined risks (e.g., depending on the rigor level and/or type of the project). In other words, the user(s) may be required to provide information about certain risks regardless of whether or not the user identifies that risk to the system. In this regard, the user(s) may be prompted to answer one or more questions regarding project risks (e.g., inherent project risks and residual project risks). In some embodiments, a user may be designated to address one or more identified risks. In some embodiments, the project module 260 may be configured to allow the user(s) to choose from several predefined options for the type of each risk, the severity of each risk, the probability of each risk, and the quality of control for each risk. By way of example, the project module 260 may prompt the user to select a risk type from a drop down menu listing predefined risk types. By way of further example, the project module 260 may prompt the user to define whether a risk has a low, medium, or high probability of occurring. In one embodiment, the risk profile of a similar program or project may be cloned to aid in the entry of risk information associated with a new project. Once the risk information has been entered, an approval request may be transmitted to one or more qualified users, who can then approve or disapprove the risk information. Based on the entered risk information (e.g., inherent risk information and residual risk information), the project module 260 may calculate an inherent risk score of the project and/or a residual risk score. The inherent risk score typically reflects the expected level of inherent risk in a project. Inherent risks are those types of risks associated with a project that are not expected to change during the execution of the project. For example, inherent risks may relate to the technology involved in a project, the line of business, and entity systems and processes impacted by the projected. Residual risk information typically reflects those types of risks that often change during project execution (e.g., quality of testing, personnel, training, and the like) rather than those types of risks that are not expected to change (e.g., inherent risks determined during the project planning phase). Indeed, many residual risks might not be identified until project execution and, thus, may be unknown while planning a project. If the inherent risk score and/or residual risk score exceeds a predefined threshold, the project module 260 may then execute a predefined risk remediation plan and/or risk management plan. In a particular embodiment, if the inherent risk score and/or residual risk score exceeds a predefined threshold, the project module 260 may be configured to not proceed past the project plan phase.

The rigor level of the project is typically the same as the rigor level of the program to which it depends. That said, in an alternative embodiment, the project module 260 may prompt the user(s) setting up the project to provide information regarding the level of rigor that should be applied to the project. In this regard, the level of rigor may relates to the level of scrutiny that is applied to the project to ensure that its associated program achieves its defined business outcomes and does not negatively impact the program. For example, a project may be determined to have a high rigor or a standard rigor depending on how critical it is to its associated program. Projects having higher rigor may be required by the project module 260 to complete additional tasks during the execution phase and may be required to complete additional quality assurance and/or quality control steps. In order to determine the level of rigor, one or more users may be prompted by the project module 260 to provide their suggested level of rigor. In addition or alternatively, the project module 260 may prompt the user(s) setting up the project to provide certain information (e.g., by presenting one or more questions to be answered by the user(s)) that can then be used by the project module 260 to calculate a rigor score. The calculated rigor and/or suggested rigor may then be provided to a predefined user, who can then review the calculated rigor and/or suggested rigor and subsequently provide the project module 260 with a final rigor level.

With respect to the task of documenting business outcomes, the project module 260 may prompt the user(s) setting up the project to provide information regarding one or more business outcomes (e.g., goals) of the project. Typically, the project module 260 is configured so that at least one business outcome must be provided. In addition, the project module 260 is typically configured so that program dependency information must be provided for each outcome. In other words, the project module 260 typically requires that the user(s) indicate which business outcomes in a related program the project's business outcomes are supposed to facilitate. In one embodiment, the user(s) may indicate whether the project's business outcomes are directly or indirectly related to certain business outcomes. If the project does not facilitate the achieve of a business outcome of the related program, the project module 260 may be configured to not proceed past the project plan phase. The project module 260 is also typically configured to prompt the user(s) setting up the project to define one or more metrics for each outcome. These metrics may be used to later measure the degree of success of the project in meeting a particular business outcome. Typically, the project module 260 is configured so that metrics must be provided for each defined business outcome. In one embodiment, users may provide forecast information regarding one or more metrics. This forecast information may relate to how the users expect the project to perform over time. Once the business outcomes and related metrics have been defined, an approval request may be transmitted to one or more qualified users, who can then approve or disapprove the defined business outcomes.

Once all of the project plan phase tasks have been completed the project module 260 may designate that the project plan phase has been completed and may allow the project execution phase to begin. That said, in one embodiment, after the project plan phase tasks have been completed, the project module 260 is configured to execute a project plan tollgate. During the project plan tollgate, project plan approval requests are sent to one or more predefined users (e.g., approvers). Each approver can then review the project plan and determine whether or not to approve the plan. Each approver can then transmit an approval or denial of the project plan to the program and project management system 200. Once every predefined approver approves the project plan, the project module 260 may designate that the project plan phase has been completed and may allow the project execution phase to begin. However, if any approver does not approve the project plan, the project module 255 will typically notify the user(s) setting up the project and provide an opportunity for the project plan to be satisfactorily revised.

Once the project plan phase has been completed, the project module 260 is typically configured to prevent any changes to the project's plan unless a predefined change control procedure is executed. Accordingly, the project module 260 typically prevents any changes to the project's risk information or defined outcomes and metrics once the project plan phase has been completed. That said, changes to the project's risk information or defined outcomes and metrics may be performed through the predefined change control procedure. The predefined change control procedure typically requires that a proposed change (e.g., requested by a user) to the project's plan be submitted to one or more predefined user(s). These predefined users may review the proposed change and then transmit a change approval or denial to the program and project management system 200. Based on receiving an approval or denial, requested changes to the project's risk information or defined outcomes and metrics may or may not be made.

Once the project plan phase has been designated as completed by the project module 260, the project module 260 will initiate the project execution phase of the project. In this regard, the project module 260 is typically configured prompt a user to complete one or more predefined execution tasks, each of which includes one or more predefined critical elements. Typically, these predefined tasks and critical elements are defined by the entity. In an exemplary embodiment, the tasks of the project execution phase may differ depending on the level of rigor of the project's related program. During the execution phase, the project module 260 may be configured to execute one or more predefined execution phase tollgates. During the execution phase tollgates, confirmation requests may be sent one or more predefined users (e.g., execution phase tollgate approvers) to confirm whether one or more of the predefined execution phase tasks have been completed. Each approver can then review the status of the tasks and determine whether or not they have been completed. Each approver can then transmit an approval or rejection regarding the satisfactory completion of the tasks to the program and project management system 200. If the tasks have not been satisfactorily completed, the project module 260 may trigger remediation.

During the execution phase, the project module 260 is typically provided data regarding the completion of one or more business outcomes. The project module 260 typically then compares this data regarding business outcomes against relevant defined metrics. The progress towards the completion of the business outcomes may then be provided by the project module 260 to users (e.g., predefined users such as project managers). For example, information regarding actual results regarding a business outcome may be displayed alongside forecasted results regarding that business outcome. The project module 260 is typically configured so that certain users (e.g., project managers) can manage resources (e.g., manage people and assign them various responsibilities and tasks), view the status of the project (e.g., progress towards one or more tasks and the project dates for deployments), view information regarding one or more related programs and projects (e.g., how the project's business outcomes relate to the business outcomes of those related programs and projects), view information regarding risks (e.g., whether or not identified risks are resolved, unresolved, or being mitigated), and initiate change controls. The project module 260 may be configured so that certain users (e.g., project managers) can view results from plan phase and execution phase quality assurance and quality control. The system may prompt users that have been assigned a task to complete that task.

In one embodiment, during the execution phase, the project module 260 is configured to collect residual risk information (e.g., updated residual risk information) regarding the project. In particular, the project module 260 may collect data relevant to residual risks from various entity systems. For example, the project module 260 may collect data regarding successful testing or completed personnel training In addition or alternatively to collecting data from entity systems, the project module 260 may prompt the user(s) to provide (e.g., periodically provide) residual risk information (e.g., updated residual risk information) regarding the project. Such risk information may include the type of each risk, a description of the risks, the severity of each risk, the probability of each risk, and the quality of control for each risk. In one embodiment, the user(s) may be prompted to provide information about certain predefined risks. In other words, the user(s) may be required to provide information about certain risks regardless of whether or not the user identifies that risk to the system. In this regard, the user(s) may be prompted to answer one or more questions regarding residual project risks. In some embodiments, the project module 260 may be configured to allow the user(s) to choose from several predefined options for the type of each risk, the severity of each risk, the probability of each risk, and the quality of control for each risk. By way of example, the project module 260 may prompt the user to select a risk type from a drop down menu listing predefined risk types. By way of further example, the project module 260 may prompt the user to define whether a risk has a low, medium, or high probability of occurring. Once the residual risk information has been entered, an approval request may be transmitted to one or more qualified users, who can then approve or disapprove the risk information.

As noted, residual risk information typically reflects those types of risks that often change during project execution (e.g., quality of testing, personnel, training, and the like) rather than those types of risks that are not expected to change (e.g., inherent risks determined during the project planning phase). Based on the residual risk information (e.g., updated residual risk information), the project module 260 may calculate a residual risk score (e.g., an updated residual risk score) of the project. Such residual risk score typically reflects the present level of risk in a project during the present stage of the execution phase. An updated risk score may also reflect the extent to which certain business outcomes have been achieved. Accordingly, the updated residual risk score for the project may differ from the project's initial residual risk score. For example, some of the risks identified during the planning phase may have been mitigated, resulting in a lower residual risk score. On the other hand, a change in circumstances may result in the project having an updated residual risk score that is higher than its initial residual risk score (e.g., risks are greater than anticipated).

Based on the updated residual risk score and the initial residual risk score, the project module 260 may then calculate a residual risk mitigation score, which reflects the extent to which residual project risks have been mitigated. For example, risk may have been mitigated based on one or more business outcome having been successfully completed (e.g., based on associated metrics being satisfied). Typically, the residual risk mitigation score is the difference between the initial residual project risk score and the updated residual project risk score. Furthermore, based on the updated residual risk score and the inherent risk score, the project module 260 may then calculate a cumulative risk score, which is typically the sum of the inherent project risk score and the updated residual project risk score. During the project planning phase, the cumulative risk score may be calculated based on the inherent project risk score and the initial residual project risk score. Once calculated, the residual risk score, cumulative risk score, and/or residual risk mitigation score may be provided to one or more users.

The residual project risk score and associated residual risk mitigation score and cumulative project risk score may be periodically calculated during the project risk phase. For example, risk information may be collected and risk scores may be calculated before one or more project deployments.

Although inherent risks are generally not expected to change, in some instances inherent risks may change, such as based on a significant change in project circumstances or active steps taken to mitigate such inherent risks. Accordingly, during the execution phase, the project module 260 may be configured to collect inherent risk information (e.g., updated inherent risk information) regarding the project and, if necessary, update the project's inherent risk score. Based on the updated inherent risk score and the initial inherent risk score, the project module 260 may then calculate an inherent risk mitigation score, which reflects the extent to which inherent project risks have been mitigated. Such an updated inherent risk score may also be used in calculating the cumulative risk score of the project.

The quality assurance and control module 275 is typically configured to execute quality assurance and quality control procedures during plan and execution phases of programs and projects.

First, the quality assurance and control module 275 is typically configured to execute plan phase quality assurance test scripts to ensure that one or more (e.g., each) predefined plan phase tasks have been completed for a program or project. In one embodiment, the tasks reviewed may depend on program or project rigor level (e.g., high rigor programs may have more tasks reviewed than standard rigor programs). Typically, plan phase quality assurance test scripts are performed for each program and project after the plan phase has been completed and before the plan tollgate. The plan phase quality assurance test scripts are typically defined by the entity and are typically designed to ensure that each predefined plan phase task has been completed. For example, these plan phase quality assurance test scripts may be designed to ensure that (i) risks have been defined and approved and (ii) business outcomes and associated metrics have been defined and approved. In one embodiment, the plan phase quality assurance test scripts are entirely automated (e.g., the quality assurance and control module 275 confirms that an approval has been documented for each predefined plan phase task). In another embodiment, the plan phase quality assurance test scripts may prompt one or more predefined users (e.g., quality assurance reviewers) to confirm that one or more predefined plan phase tasks have been satisfactorily completed and that an approval has been documented. Once the plan phase quality assurance test scripts have been completed, the quality assurance and control module 275 typically generates a plan phase quality assurance score. This plan phase quality assurance score typically reflects the extent to which the predefined plan phase tasks have been satisfactorily completed. This plan phase quality assurance score may then be compared (e.g., by the quality assurance and control module 275) to a plan phase quality assurance score threshold (e.g., 90 percent). If the plan phase quality assurance score meets or exceeds the plan phase quality assurance score threshold, then the program or project is allowed (e.g., by the quality assurance and control module 275) to proceed to the plan tollgate. That said, if the plan phase quality assurance score is less than the plan phase quality assurance score threshold, then the program or project is typically prevented from proceeded to the plan tollgate. Alternatively, the plan phase quality assurance score may simply indicate whether the predefined plan phase tasks have or have not been satisfactorily completed. In this regard, if all of the predefined plan phase tasks have been completed the project may proceed to the plan tollgate, otherwise the program or project is prevented from proceeding to the plan tollgate. In some embodiments, the user(s) setting up the program or project may be provided with an opportunity by the program and project management system 200 to engage in remediation by revisiting any unsatisfactory plan phase task, after which the program or project can again undergo plan phase quality assurance testing.

Next, the quality assurance and control module 275 typically configured to perform plan phase quality control. Plan phase quality control is typically performed after the plan tollgate and may be performed at the same time as the execution phase. In some embodiments, plan phase quality control is performed for each program and project. In other embodiments, plan phase quality control is performed for a random sample of programs and projects at a predefined rate (e.g., twenty percent). The predefined rate for performing plan phase quality control may be based on program rigor level. For example, plan phase quality control may be performed for all high rigor programs and their associated projects, whereas plan phase quality control may be performed for twenty percent of standard rigor programs and their associated projects.

To perform plan phase quality control, the quality assurance and control module 275 is typically configured to prompt one or more predefined users (e.g., quality control reviewers) to review that one or more (e.g., each) predefined plan phase task has been satisfactorily completed. In one embodiment, the tasks reviewed may depend on program or project rigor level (e.g., high rigor programs may have more tasks reviewed than standard rigor programs). The users (e.g., quality control reviewers) will then provide the quality assurance and control module 275 with an indication of whether each predefined plan phase task has been satisfactorily completed. Whether or not each predefined plan phase task has been satisfactorily completed is then typically used by the quality assurance and control module 27 to generate a plan phase quality control score, which reflects the extent to which the predefined plan phase tasks have been satisfactorily completed. The plan phase quality control score is then typically compared to a plan phase quality control score threshold (e.g., 90 percent). In one embodiment, there may be multiple plan phase quality control score thresholds to reflect the degree of satisfactory completion of the plan phase. Typically, if the plan phase quality control score meets or exceeds the plan phase quality control score threshold (e.g., 90 percent), then the quality assurance and control module 275 generates a report indicating that the plan phase quality control score meets or exceeds the threshold. Alternatively, if the plan phase quality control score does not meets or exceed the plan phase quality control score threshold (e.g., 90 percent), then the quality assurance and control module 275 generates a report indicating that the plan phase quality control score does not meet or exceed the threshold. In one embodiment, if the plan phase quality control score does not meet or exceed the threshold, then the user(s) setting up the program or project may be prompted by the program and project management system 200 to engage in remediation by revisiting any unsatisfactory plan phase task (e.g., through predefined change control procedures), after which the program or project can again undergo plan phase quality control testing. In one embodiment, whether or not users are prompted to engage in plan phase remediate may depend on the rigor level of the program or project. For example, users may be prompted to remediate any incomplete or unsatisfactory tasks of high rigor programs, whereas users may not be prompted to remediate any incomplete or unsatisfactory tasks of standard rigor programs.

After a program or project passes the plan tollgate, the quality assurance and control module 275 is typically configured to execute execution phase quality assurance test scripts to ensure that one or more (e.g., each) predefined tasks have been completed for a program or project. In one embodiment, the tasks reviewed may depend on program or project rigor level (e.g., high rigor programs may have more tasks reviewed than standard rigor programs). Typically, execution phase quality assurance test scripts are performed for each program and project after plan tollgate approval (e.g., a predefined time, such as ninety days, after plan tollgate approval). The execution phase quality assurance test scripts are typically defined by the entity and are typically designed to ensure that one or more predefined execution phase task (e.g., each predefined execution phase task) has been completed. For example, these execution phase quality assurance test scripts may be designed to ensure that defined business outcomes have been met by comparing data related to the business outcomes with the associated metrics. In one embodiment, the execution phase quality assurance test scripts are entirely automated (e.g., the quality assurance and control module 275 confirms that the metrics related to a business outcome have been met). In another embodiment, the execution phase quality assurance test scripts may prompt one or more predefined users (e.g., quality assurance reviewers) to confirm that one or more predefined execution phase tasks have been completed. Once the execution phase quality assurance test scripts have been completed, the quality assurance and control module 275 typically generates an execution phase quality assurance score. This execution phase quality assurance score typically reflects the extent to which the predefined execution phase tasks have been satisfactorily completed. This execution phase quality assurance score may then be compared (e.g., by the quality assurance and control module 275) to an execution phase quality assurance score threshold (e.g., 90 percent). If the execution phase quality assurance score meets or exceeds the execution phase quality assurance score threshold, then the program or project is allowed (e.g., by the quality assurance and control module 275) to proceed to execution phase quality control. That said, if the execution phase quality assurance score is less than the execution phase quality assurance score threshold, then the program or project is typically prevented from proceeding to execution phase quality control or being designated as completed. Alternatively, the execution phase quality assurance score may simply indicate whether the predefined execution phase tasks have or have not been satisfactorily completed. In this regard, if all of the predefined execution phase tasks have been satisfactorily completed the project may proceed to execution phase quality control or be designated as completed, otherwise the program or project is prevented from proceeding to execution phase quality control or being designated as completed. In some embodiments, remediation of the program or project may be performed by prompting users to re-execute one or more of the predefined execution tasks (e.g., any task that has not been completed), after which the program or project can again undergo execution phase quality assurance testing.

Next, the quality assurance and control module 275 typically configured to perform execution phase quality control. Execution phase quality control is typically performed after execution phase quality assurance has been satisfactorily completed (e.g., the execution phase quality assurance score meets or exceeds the execution phase quality assurance score threshold). That said, in some embodiments execution phase quality control is performed a predefined time after passing the plan tollgate (e.g., 120 days after) regardless of whether execution phase quality assurance has been performed. In some embodiments, execution phase quality control is performed for each program and project. In other embodiments, execution phase quality control is performed for a random sample of programs and projects at a predefined rate (e.g., twenty percent). The predefined rate for performing execution phase quality control may be based on program rigor level. For example, execution phase quality control may be performed for all high rigor programs and their associated projects, whereas execution phase quality control may be performed for twenty percent of standard rigor programs and their associated projects.

To perform execution phase quality control, the quality assurance and control module 275 is typically configured to prompt one or more predefined users (e.g., quality control reviewers) to review that one or more (e.g., each) predefined execution phase task has been satisfactorily completed. In one embodiment, the tasks reviewed may depend on program or project rigor level (e.g., high rigor programs may have more tasks reviewed than standard rigor programs). The users (e.g., quality control reviewers) will then provide the quality assurance and control module 275 with an indication of whether the predefined execution phase tasks have been satisfactorily completed (e.g., by ensuring that defined business outcomes met achieved their associated metrics). Whether or not each predefined execution phase task has been satisfactorily completed is then typically used by the quality assurance and control module 27 to generate execution phase quality control score, which reflects the extent to which predefined execution phase tasks have been satisfactorily completed. The execution phase quality control score is then typically compared to an execution phase quality control score threshold (e.g., 90 percent). In one embodiment, there may be multiple execution phase quality control score thresholds to reflect the degree of satisfactory completion of the execution phase. Typically, if the execution phase quality control score meets or exceeds the execution phase quality control score threshold (e.g., 90 percent), then the quality assurance and control module 275 generates a report indicating that the execution phase quality control score meets or exceeds the threshold. Alternatively, if the execution phase quality control score does not meets or exceed the execution phase quality control score threshold (e.g., 90 percent), then the quality assurance and control module 275 generates a report indicating that the execution phase quality control score does not meet or exceed the threshold. In one embodiment, if the plan phase quality control score does not meet or exceed the threshold, then users be prompted by the program and project management system 200 to engage in remediation by re-executing any incomplete or unsatisfactory execution phase task (e.g., through predefined change control procedures), after which the program or project can again undergo execution phase quality control testing. In one embodiment, whether or not users are prompted to engage in execution phase remediate may depend on the rigor level of the program or project. For example, users may be prompted to remediate any incomplete or unsatisfactory tasks of high rigor programs, whereas users may not be prompted to remediate any incomplete or unsatisfactory tasks of standard rigor programs.

Finally, once a program or project has satisfactorily completed execution phase quality assurance and/or execution phase quality control, the program and project management system 200 may designate that the program or project has being satisfactorily completed.

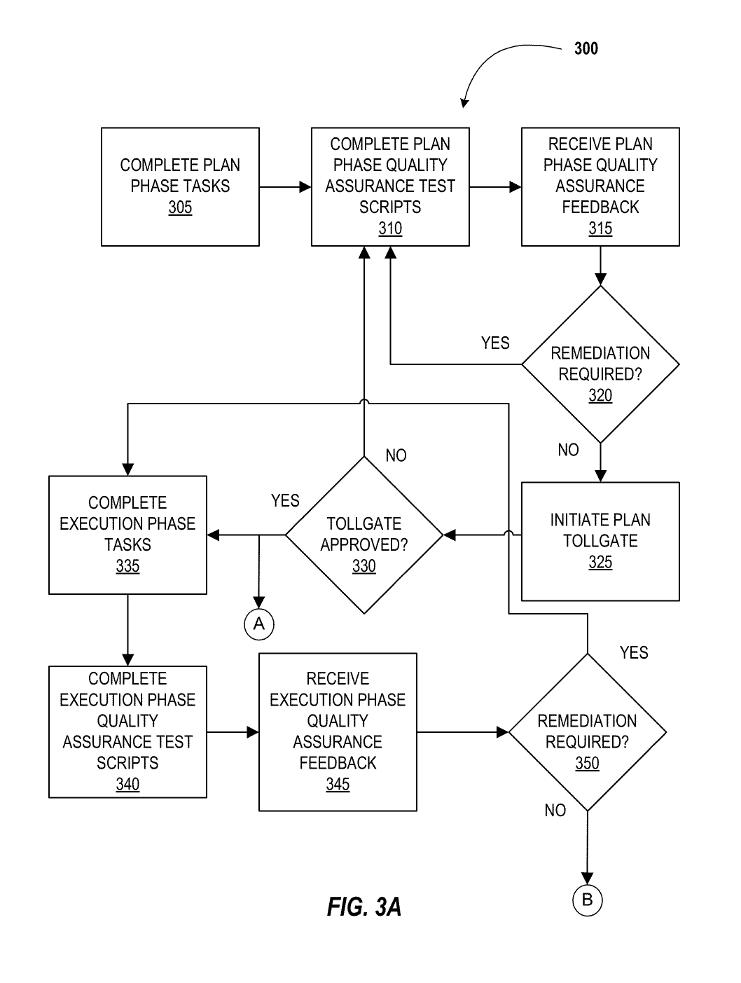

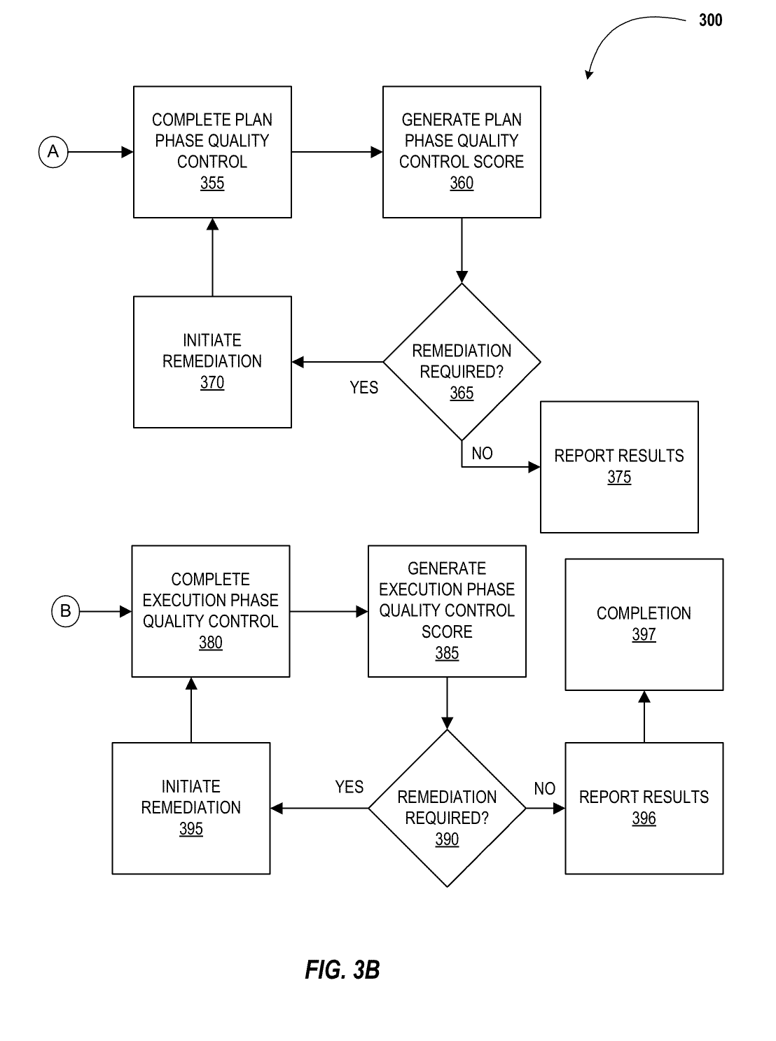

FIGS. 3A-3B depicts a method 300 of program and project management in accordance with an aspect of the present invention. The method 300 depicted in FIGS. 3A-3B is applicable to both program and projects as described herein.

First, in block 305, the program and project management system 200 typically prompts a user to complete one or more predefined plan phase tasks for the program or project that the user wishes to initiate. For example, the program and project management system 200 will typically prompt the user to define business outcomes and associated metrics and to evaluate the inherent risks and/or residual risks of the program or project. Using information regarding inherent risks, the system may calculate an inherent risk score and/or a residual risk score.

Next, in block 310, the program and project management system 200 completes plan phase quality assurance test scripts, which evaluate whether the predefined plan phase tasks have been completed (e.g., to ensure that (i) risks have been defined and approved and (ii) business outcomes and associated metrics have been defined and approved). The system may complete the plan phase quality assurance test scripts after the user has indicated that the plan phase tasks have been completed. In running these test scripts the program and project management system 200 may prompt a quality assurance reviewer to indicate whether each predefined program plan phase task has been satisfactorily completed.

In block 315, the program and project management system 200 typically receives plan phase quality assurance feedback as a result of running the plan phase quality assurance test scripts. For example, the system may receive an indication from the quality assurance reviewer that each predefined program plan phase task has or has not been satisfactorily completed.

In block 320, the program and project management system 200 determines whether remediation of the program or project plan is required. Typically, if the quality assurance reviewer indicates that each predefined program plan phase task has not been satisfactorily completed, then remediation of the program or project is typically required. In this regard, the program and project management system 200 may allow users to engage in remediation by revisiting (e.g., revising) any unsatisfactory plan phase task, after which the program or project can again undergo plan phase quality assurance testing.

If the quality assurance reviewer indicates that each predefined program plan phase task has been satisfactorily completed, then, in block 325, the program and project management system 200 initiates a program or project plan tollgate by sending plan approval requests to one or more predefined users (e.g., approvers). Each approver can then transmit an approval or denial of the plan to the program and project management system 200.

In block 330, the program and project management system 200 determines whether each approver has approved the program or project plan. If any approver does not approve the program or project plan, the program and project management system 200 will typically notify the user(s) setting up the program or project and provide an opportunity for the plan to be satisfactorily revised (e.g., by re-completing one or more plan phase tasks).

If every predefined approver approves the program or project plan, then, in block 355, the program and project management system 200 will typically complete plan phase quality control. In some embodiments, whether or not plan phase quality control is performed is based on program rigor level. For example, plan phase quality control may be performed for all high rigor programs and their associated projects, whereas plan phase quality control may be performed for a predefined percentage of standard rigor programs and their associated projects. To perform plan phase quality control, the program and project management system 200 will typically prompt one or more predefined users (e.g., quality control reviewers) to review that each predefined plan phase task has been satisfactorily completed.

Based upon the feedback received from the quality control reviewers, in block 360, the program and project management system 200 will typically generate a plan phase quality control score, which reflects the extent to which the predefined plan phase tasks have been satisfactorily completed.

In block 365, the program and project management system 200 determines whether remediation is required, typically by comparing the plan phase quality control score to a predefined plan phase quality control score threshold (e.g., 90 percent). If the plan phase quality control score does not meet or exceed the plan phase quality control score threshold, then, in block 370, the user(s) setting up the program or project may be provided with an opportunity by the program and project management system 200 to engage in remediation by revisiting any unsatisfactory plan phase task (e.g., through predefined change control procedures), after which the program or project can again undergo plan phase quality control testing.

If the plan phase quality control score does meet or exceed the plan phase quality control score threshold, then, in block 375, the program and project management system 200 reports the satisfactory completion of the plan phase quality control (e.g., to a program or project manager).

Returning to block 330, if every predefined approver approves the program or project plan, then, in block 355, the program and project management system 200 will also initiate the execution phase of the program or project in block 335. In particular, the program and project management system 200 will typically prompt users to complete one or more predefined execution phase tasks. During the execution phase, the system may periodically collect updated residual risk information (e.g., by prompting the user(s) to provide updated residual risk information). Using this updated residual risk information, the system may periodically determine an updated residual risk score. Furthermore, the system may periodically determine a cumulative risk score and a residual risk mitigation score.

Next, in block 340, the program and project management system 200 will typically execute execution phase quality assurance test scripts to ensure that one or more predefined execution phase tasks have been completed for a program or project. For example, these execution phase quality assurance test scripts may be designed to ensure that defined business outcomes have been met by comparing data related to the business outcomes with the associated metrics. In running these test scripts the program and project management system 200 may prompt the quality assurance reviewer to indicate whether each predefined program execution phase task has been satisfactorily completed. In one embodiment, the program and project management system 200 may automatically execute the execution phase quality assurance test scripts after a predetermined period of time following plan tollgate approval.

In block 345, the program and project management system 200 typically receives execution phase quality assurance feedback as a result of running the execution phase quality assurance test scripts. For example, the system may receive an indication from the quality assurance reviewer that each predefined program execution phase task has or has not been satisfactorily completed.

In block 350, the program and project management system 200 determines whether remediation is required. Typically, if the quality assurance reviewer indicates that each predefined program execution phase task has not been satisfactorily completed, then remediation of the program or project is typically required. In this regard, the program and project management system 200 may allow users to engage in remediation by revisiting (e.g., revising) any unsatisfactory execution phase task, after which the program or project can again undergo execution phase quality assurance testing. For example, users may re-execute one or more of the predefined execution tasks, such as any incomplete task.

If the quality assurance reviewer indicates that each predefined program execution phase task has been satisfactorily completed, then, in block 380, the program and project management system 200 typically completes execution phase quality control. In some embodiments, whether or not execution phase quality control is performed is based on program rigor level. For example, execution phase quality control may be performed for all high rigor programs and their associated projects, whereas execution phase quality control may be performed for a predefined percentage of standard rigor programs and their associated projects. Execution phase quality control is typically performed after execution phase quality assurance has been satisfactorily completed (e.g., the execution phase quality assurance score meets or exceeds the execution phase quality assurance score threshold). That said, in some embodiments execution phase quality control is performed a predefined time after passing the plan tollgate (e.g., 120 days after) regardless of whether execution phase quality assurance has been performed. To perform execution phase quality control, the program and project management system 200 will typically prompt one or more predefined users (e.g., quality control reviewers) to review that one or more (e.g., each) predefined execution phase task has been satisfactorily completed. The users (e.g., quality control reviewers) will then provide the program and project management system 200 with an indication of whether the predefined execution phase tasks have been satisfactorily completed (e.g., by ensuring that defined business outcomes achieved their associated metrics).

In block 385, the program and project management system 200 then generates an execution phase quality control score, which reflects the extent to which predefined execution phase tasks have been satisfactorily completed.

In block 390, the program and project management system 200 determines whether remediation is required, typically by comparing the execution phase quality control score to a predefined execution phase quality control score threshold (e.g., 90 percent).

If the execution phase quality control score does not meet or exceed the execution phase quality control score threshold, then, in block 395, the program and project management system 200 may prompt users to engage in remediation. In some embodiments, remediation of the program or project may be performed by prompting users to re-execute one or more of the predefined execution tasks (e.g., any task that has not been satisfactorily completed), after which the program or project can again undergo execution phase quality control testing.

However, if the plan phase quality control score does meet or exceed the plan phase quality control score threshold, then, in block 396, the program and project management system 200 generates a report indicating that the execution phase quality control score matches the execution phase quality assurance score.

Finally, in block 397, the program and project management system 200 may indicate the program or project has been satisfactorily completed.

In one embodiment, the program and project management system 200 may include an aggregation module. The aggregation module is typically configured for collecting and displaying information and data regarding a plurality of programs and projects. In this regard, the aggregation module may be configured to collect risk information, rigor information, information regarding the completion of defined business metrics, quality assurance information (e.g., plan phase quality assurance score, execution phase quality assurance score, and whether or not remediation was performed), quality control information (e.g., plan phase quality control score, execution phase quality control score, and whether or not remediation was performed), progress information regarding tasks and deployments, and the like regarding a plurality of programs and/or projects. This information may then be organized and displayed by the program and project management system 200 to one or more users. For example, this information may be presented to users via a graphical user interface (GUI).

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A risk-based project management system, comprising:
a processor;
a memory;
a project module stored in the memory, executable by the processor and configured for:
receiving a first indication from a first user to initiate a project;
based on the first indication to initiate the project, prompting the first user to complete predefined project plan phase tasks, wherein prompting the first user to complete the predefined project plan phase tasks comprises prompting the first user to provide inherent risk information regarding the project, and define one or more business outcomes and associated metrics for the project;
receiving inherent risk information regarding the project and one or more defined business outcomes for the project from the first user, wherein each defined project business outcome includes one or more associated metrics,
based on the received inherent project risk information, calculating an inherent project risk score;
receiving a second indication from the first user that the predefined project plan phase tasks have been completed;
prompting the first user to complete predefined project execution phase tasks;
receiving residual risk information regarding the project; and
based on the received residual project risk information, calculating a residual project risk score.

2. The risk-based project management system according to claim 1, wherein the project module is configured for:
determining whether each defined project business outcome includes one or more associated metrics;
comparing the inherent project risk score to a predefined project risk score threshold;
based on (i) the inherent project risk score not exceeding the predefined project risk score threshold, (ii) each defined project business outcome including one or more associated metrics, and (iii) the second indication that the predefined project plan phase tasks have been completed, initiating a project plan tollgate, wherein initiating the project plan tollgate comprises sending one or more project plan approval requests to one or more predefined project plan tollgate approvers; and
receiving a project plan approval from each predefined project plan tollgate approver;
wherein prompting the first user to complete predefined project execution phase tasks is based on receiving a project plan approval from each predefined project plan tollgate approver.

3. The risk-based project management system according to claim 1, wherein the project module is configured for:
before prompting the first user to complete the predefined project execution phase tasks, receiving initial residual risk information regarding the project, and, based on the received initial residual project risk information, calculating an initial residual project risk score;
after prompting the first user to complete predefined project execution phase tasks, receiving updated residual risk information regarding the project, and, based on the received updated residual project risk information, calculating an updated residual project risk score; and
calculating a project residual risk mitigation score, the residual risk mitigation score being the difference between the initial residual project risk score and the updated residual project risk score.

4. The risk-based project management system according to claim 1, wherein the project module is configured for calculating a cumulative project risk score, the cumulative project risk score being the sum of the inherent project risk score and the residual project risk score.

5. The risk-based project management system according to claim 1, wherein the project module is configured for, after prompting the first user to complete predefined project execution phase tasks, prompting the first user to provide residual risk information regarding the project.

6. The risk-based project management system according to claim 5, wherein:
prompting the first user to provide residual risk information regarding the project comprises periodically prompting the first user to provide residual risk information regarding the project; and
calculating a residual project risk score comprises periodically calculating a residual project risk score based on periodically received residual project risk information.

7. The risk-based project management system according to claim 5, wherein:
prompting the first user to provide inherent risk information regarding the project comprises prompting the first user to answer one or more questions regarding inherent risk;
receiving inherent risk information regarding the project comprises receiving answers to the one or more questions regarding inherent risk from the first user;
prompting the first user to provide residual risk information regarding the project comprises prompting the first user to answer one or more questions regarding residual risk; and
receiving residual risk information regarding the project comprises receiving answers to the one or more questions regarding residual risk from the first user.

8. A computer program product for providing risk-based project management, comprising a non-transitory computer-readable storage medium having computer-executable instructions for:
receiving a first indication from a first user to initiate a project;
based on the first indication to initiate the project, prompting the first user to complete predefined project plan phase tasks, wherein prompting the first user to complete the predefined project plan phase tasks comprises prompting the first user to provide inherent risk information regarding the project, and define one or more business outcomes and associated metrics for the project;
receiving inherent risk information regarding the project and one or more defined business outcomes for the project from the first user, wherein each defined project business outcome includes one or more associated metrics,
based on the received inherent project risk information, calculating an inherent project risk score;
receiving a second indication from the first user that the predefined project plan phase tasks have been completed;
prompting the first user to complete predefined project execution phase tasks;
receiving residual risk information regarding the project; and
based on the received residual project risk information, calculating a residual project risk score.

9. The computer program product according to claim 8, wherein the non-transitory computer-readable storage medium has computer-executable instructions for:
determining whether each defined project business outcome includes one or more associated metrics;
comparing the inherent project risk score to a predefined project risk score threshold;
based on (i) the inherent project risk score not exceeding the predefined project risk score threshold, (ii) each defined project business outcome including one or more associated metrics, and (iii) the second indication that the predefined project plan phase tasks have been completed, initiating a project plan tollgate, wherein initiating the project plan tollgate comprises sending one or more project plan approval requests to one or more predefined project plan tollgate approvers; and
receiving a project plan approval from each predefined project plan tollgate approver;
wherein prompting the first user to complete predefined project execution phase tasks is based on receiving a project plan approval from each predefined project plan tollgate approver.

10. The computer program product according to claim 8, wherein the non-transitory computer-readable storage medium has computer-executable instructions for:
before prompting the first user to complete the predefined project execution phase tasks, receiving initial residual risk information regarding the project, and, based on the received initial residual project risk information, calculating an initial residual project risk score;
after prompting the first user to complete predefined project execution phase tasks, receiving updated residual risk information regarding the project, and, based on the received updated residual project risk information, calculating an updated residual project risk score; and
calculating a project residual risk mitigation score, the residual risk mitigation score being the difference between the initial residual project risk score and the updated residual project risk score.

11. The computer program product according to claim 8, wherein the non-transitory computer-readable storage medium has computer-executable instructions for calculating a cumulative project risk score, the cumulative project risk score being the sum of the inherent project risk score and the residual project risk score.

12. The computer program product according to claim 8, wherein the non-transitory computer-readable storage medium has computer-executable instructions for, after prompting the first user to complete predefined project execution phase tasks, prompting the first user to provide residual risk information regarding the project;

13. The computer program product according to claim 12, wherein:
prompting the first user to provide residual risk information regarding the project comprises periodically prompting the first user to provide residual risk information regarding the project; and
calculating a residual project risk score comprises periodically calculating a residual project risk score based on periodically received residual project risk information.

14. The computer program product according to claim 12, wherein:
prompting the first user to provide inherent risk information regarding the project comprises prompting the first user to answer one or more questions regarding inherent risk;
receiving inherent risk information regarding the project comprises receiving answers to the one or more questions regarding inherent risk from the first user;
prompting the first user to provide residual risk information regarding the project comprises prompting the first user to answer one or more questions regarding residual risk; and
receiving residual risk information regarding the project comprises receiving answers to the one or more questions regarding residual risk from the first user.

15. A method of providing risk-based project management, comprising:
receiving, via a processor, a first indication from a first user to initiate a project;
based on the first indication to initiate the project, prompting, via a processor, the first user to complete predefined project plan phase tasks, wherein prompting the first user to complete the predefined project plan phase tasks comprises prompting the first user to provide inherent risk information regarding the project, and define one or more business outcomes and associated metrics for the project;
receiving, via a processor, inherent risk information regarding the project and one or more defined business outcomes for the project from the first user, wherein each defined project business outcome includes one or more associated metrics, based on the received inherent project risk information, calculating, via a processor, an inherent project risk score;
receiving, via a processor, a second indication from the first user that the predefined project plan phase tasks have been completed;
prompting, via a processor, the first user to complete predefined project execution phase tasks;
receiving, via a processor, residual risk information regarding the project; and
based on the received residual project risk information, calculating, via a processor, a residual project risk score.

16. The method according to claim 15, wherein the project module is configured for:
determining whether each defined project business outcome includes one or more associated metrics;
comparing the inherent project risk score to a predefined project risk score threshold;
based on (i) the inherent project risk score not exceeding the predefined project risk score threshold, (ii) each defined project business outcome including one or more associated metrics, and (iii) the second indication that the predefined project plan phase tasks have been completed, initiating a project plan tollgate, wherein initiating the project plan tollgate comprises sending one or more project plan approval requests to one or more predefined project plan tollgate approvers; and
receiving a project plan approval from each predefined project plan tollgate approver;
wherein prompting the first user to complete predefined project execution phase tasks is based on receiving a project plan approval from each predefined project plan tollgate approver.

17. The method according to claim 15, comprising:
before prompting the first user to complete the predefined project execution phase tasks, receiving initial residual risk information regarding the project, and, based on the received initial residual project risk information, calculating an initial residual project risk score;
after prompting the first user to complete predefined project execution phase tasks, receiving updated residual risk information regarding the project, and, based on the received updated residual project risk information, calculating an updated residual project risk score; and
calculating a project residual risk mitigation score, the residual risk mitigation score being the difference between the initial residual project risk score and the updated residual project risk score.

18. The method according to claim 15, comprising calculating a cumulative project risk score, the cumulative project risk score being the sum of the inherent project risk score and the residual project risk score.

19. The method according to claim 15, comprising, after prompting the first user to complete predefined project execution phase tasks, prompting the first user to provide residual risk information regarding the project;

20. The method according to claim 19, wherein:
prompting the first user to provide residual risk information regarding the project comprises periodically prompting the first user to provide residual risk information regarding the project; and
calculating a residual project risk score comprises periodically calculating a residual project risk score based on periodically received residual project risk information.

21. The method according to claim 19, wherein:
prompting the first user to provide inherent risk information regarding the project comprises prompting the first user to answer one or more questions regarding inherent risk;
receiving inherent risk information regarding the project comprises receiving answers to the one or more questions regarding inherent risk from the first user;
prompting the first user to provide residual risk information regarding the project comprises prompting the first user to answer one or more questions regarding residual risk; and
receiving residual risk information regarding the project comprises receiving answers to the one or more questions regarding residual risk from the first user.
